(19) United States
(12) Patent Application Publication
(10) Pub. No.: US 2026/0217918 A1
(43) Pub. Date: Jul. 30, 2026

(54) ALKOXY-FUNCTIONAL SILSESQUIOXANE RESIN AND PROCESSES FOR THE PREPARATION AND USE THEREOF

(71) Applicants: Dow Silicones Corporation, Midland, MI (US); Dow Global Technologies LLC, Midland, MI (US)

(72) Inventors: Steven Swier, Midland, MI (US); Stephane Ugazio, Seneffe (BE); Hongyun Xu, Midland, MI (US); Junying Liu, Auburn, MI (US); John Horstman, Midland, MI (US)

(21) Appl. No.: 19/144,324

(22) PCT Filed: Dec. 7, 2023
(86) PCT No.: PCT/US2023/082798

§ 371 Date: Jun. 27, 2025

Related U.S. Application Data
(60) Provisional application No. 63/453,261, filed on Mar. 20, 2023.

(51) Int. Cl. C08G 77/18; C08G 77/50; C09D 183/14

(52) U.S. Cl. CPC C08G 77/18; C08G 77/50; C09D 183/14

(57) ABSTRACT

An alkoxy-functional silsesquioxane resin and hydrosilylation reaction processes for its preparation are provided. The alkoxy-functional silsesquioxane resin is a liquid under ambient conditions and is useful in solvent-borne and solventless moisture curable compositions, such as coating compositions.

### CROSS REFERENCE TO RELATED APPLICATIONS

This application claims the benefit of U.S. Provisional Patent Application Ser. No. 63/453,261 filed on 20 Mar. 2023 under 35 U.S.C. § 119 (e). U.S. Provisional Patent Application Ser. No. 63/453,261 is hereby incorporated by reference.

### FIELD

An alkoxy-functional silsesquioxane resin and processes for its preparation are provided. The alkoxy-functional silsesquioxane resin is useful in moisture curable compositions, which are suitable for forming coatings.

### INTRODUCTION

The coatings industry faces pressures to reduce the use of volatile organic compounds (VOCs) for more environmentally friendly solutions. Consequently, solvent free liquid products are desirable to leverage silicone resin benefits in high performance applications. For example, temperature resistant coatings that are delivered from a solvent-free moisture curable composition are desired to replace less desirable solvent-borne options. Moreover, since room temperature curable compositions are preferred for certain application, moisture cure is desirable.

Solvent-free liquid silicone resins typically suffer from slower cure times than solvent-borne coating compositions because intrinsically lower glass transition resins need to be used, which are undesirable for the final desired hard coating performance.

Therefore, there is an industry need to improve cure speed of moisture curable compositions containing siloxane resins.

### SUMMARY

An alkoxy-functional silsesquioxane resin and methods for the preparation thereof are provided. The alkoxy-functional silsesquioxane resin may be formulated into a moisture curable composition, such as a coating composition.

### DETAILED DESCRIPTION

The alkoxy-functional silsesquioxane resin comprises unit formula:

(R²₃SiO_{1/2})_{c}(R²₂SiO_{2/2})_{d}(R²SiO_{3/2})ₑ(ZO_{1/2})_{f}(HO_{1/2})_{g}; where
each R² is independently selected from the group consisting of an alkyl group and a group of formula (I)

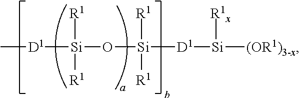

where in formula (I),
   each R¹ is an independently selected alkyl group,
   each D¹ is an independently selected alkylene group,
   subscripts a, b, and x are integers with values such that
      subscript a is 1 or 2,
      subscript b is 0 or 1, and
      subscript x is 0 or 1;
      with the proviso that an average of 5 mol % to 25 mol % the groups R², per molecule, have formula (I);
subscripts c, d, and e represent mole fractions of each unit in the alkoxy-functional silsesquioxane resin and subscripts c, d, and e have values such that

$$0 \leq c \leq 0.25 ,$$

$$0 \leq d \leq 0.20 ,$$

$$0.55 < e \leq 1 , and$$

$$a quantity ( c + d + e ) = 1 ;$$

each Z is an independently selected alkyl group; and
subscript f represents a molar amount of alkoxy groups in the alkoxy-functional silsesquioxane resin, and subscript g represents a molar amount of hydroxyl groups in the alkoxy-functional silsesquioxane resin, and subscripts f and g have values such that

$$0.01 \leq f \leq 0.7 ;$$

$$0 \leq g \leq 0.05 ; and$$

$$0.02 \leq ( f + g ) \leq 0.75 .$$

In the unit formula above, subscripts c, d, and e represent mole fractions of each unit in the alkoxy-functional silsesquioxane resin. A quantity (c+d+e)=1. Subscripts c, d, and e have values such that 0≤c≤0.25, 0≤d≤0.20, and 0.55<e≤1. Subscript c may be 0, alternatively >0, alternatively at least 0.100, alternatively at least 0.101, alternatively at least 0.102, alternatively at least 0.110, alternatively at least 0.120, and alternatively at least 0.130; while at the same time, subscript c may be up to 0.300, alternatively up to 0.250, alternatively up to 0.240, alternatively up to 0.200, and alternatively up to 0.150 alternatively up to 0.110. Alternatively, subscript c may be 0 to 0.300, alternatively 0 to 0.250, alternatively 0.100 to 0.240, and alternatively 0.102 to 0.240.

Subscript d may be 0, alternatively >0, alternatively at least 0.001, alternatively at least 0.002, alternatively at least 0.003, alternatively at least 0.004, alternatively at least 0.005, and alternatively at least 0.006; while at the same time, subscript d may be up to 0.020, alternatively up to 0.015, alternatively up to 0.010, alternatively up to 0.009, alternatively up to 0.008, alternatively up to 0.007, and alternatively up to 0.006. Alternatively, subscript d may be 0 to 0.020, alternatively >0 to 0.015, and alternatively 0.006 to 0.010.

Subscript e is >0.55 to 1. Alternatively, subscript e may be at least 0.550, alternatively at least 0.600, alternatively at least 0.650, alternatively at least 0.700, alternatively at least 0.750, alternatively at least 0.800; while at the same time, subscript e may be up to 1, alternatively up to 0.995, alternatively up to 0.991, alternatively up to 0.95, alternatively up to 0.925, alternatively up to 0.920, alternatively up to 0.915, alternatively up to 0.910, alternatively up to 0.905, and alternatively up to 0.0900. Alternatively, subscript e may be 0.905 to 1, alternatively 0.910 to 1, alternatively 0.915 to 1, alternatively 0.990 to 1, alternatively 0.991 to 1, alternatively 0.995 to 1, and alternatively subscript e may be 1.

In the unit formula above, each Z is an independently selected alkyl group. Suitable alkyl groups may be cyclic or acyclic, branched or unbranched, or a combination thereof. Alkyl groups are exemplified by, but not limited to, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, tert-pentyl, and/or cyclopentyl), hexyl (e.g., cyclohexyl or n-hexyl), heptyl, octyl, nonyl, and decyl, as well as branched alkyl groups of 6 or more carbon atoms. Alternatively, each Z may be an alkyl group of 1 to 4 carbon atoms, alternatively 1 to 2 carbon atoms. Each Z may be methyl or ethyl; alternatively methyl.

The units (HO_{1/2}) and (ZO_{1/2}) represent hydroxyl and alkoxy groups, respectively, bonded to silicon atoms in resin (e.g., the hydroxyl and alkoxy groups are bonded to silicon atoms in the resinous portion of the alkoxy-functional silsesquioxane resin, which are portions of the molecule other than the grafted R² group of formula (I)). Without wishing to be bound by theory, it is thought that the hydroxyl and/or alkoxy groups may be bonded to any one or more of the silicon atoms in the monofunctional units of formula (R²₃SiO_{1/2}), the difunctional units of formula (R²₂SiO_{2/2}), and the trifunctional units of formula (R²SiO_{3/2}) in the alkoxy-functional silsesquioxane resin.

In the unit formula above, each alkyl group, R², is independently selected, and may be an alkyl group as described above for Z. Alternatively, each alkyl group for R² may be methyl. However, at least some groups R² have formula (I) (e.g., are the result of the hydrosilylation reaction in the method described below). In the unit formula, 5 mol % to 25 mol % of all R² groups may have formula (I) while the balance to 100 mol % of all R² groups are alkyl. Alternatively, at least 5 mol %, alternatively at least 6 mol %, alternatively at least 8 mol %, alternatively at least 9 mol %, alternatively at least 10 mol %, alternatively at least 13 mol %, alternatively at least 14 mol %, and alternatively at least 15 mol % of all R² groups have formula (I); while at the same time up to 25 mol %, alternatively up to 23 mol %, alternatively up to 20 mol %, alternatively up to 15 mol %, alternatively up to 14 mol %, alternatively up to 13 mol %, and alternatively up to 12 mol % of all R² groups have formula (I). Alternatively, the amount of R² groups with formula (I) may be 5 mol % to 25 mol %, alternatively 5 mol % to 23 mol %, alternatively 6 mol % to 15 mol %.

In the unit formula above, subscript f represents a molar amount of alkoxy groups in the resin, and subscript g represents a molar amount of hydroxyl groups in the resin. Subscripts f and g have values such that 0.01≤f≤0.70; 0≤g≤0.05; and 0.02≤(f+g)≤0.75. Alternatively, subscript f may have a value of at least 0.01, alternatively at least 0.10, alternatively at least 0.20, alternatively at least 0.30; while at the same time, subscript f may have a value up to 0.70, alternatively up to 0.60, alternatively up to 0.56, alternatively up to 0.52. Alternatively, subscript f may have a value such that 0.10≤f≤0.60, alternatively 0.30≤f≤0.60; alternatively 0.37≤f≤0.56; and alternatively 0.37≤f≤0.44. Alternatively, subscript g may have a value of at least 0.005, alternatively at least 0.008, alternatively at least 0.01; while at the same time, subscript g may have a value up to 0.05, alternatively up to 0.049, alternatively up to 0.045, alternatively up to 0.040, alternatively up to 0.035. Alternatively, subscript g may have a value such that 0.005≤g≤0.05, alternatively 0.006≤g≤0.049; alternatively 0.006≤g≤0.035; and alternatively 0.008≤g≤0.05. Alternatively, the quantity (f+g) may at least 0.02, alternatively at least 0.20, alternatively at least 0.30, alternatively at least 0.40, alternatively at least 0.41, alternatively at least 0.43, alternatively at least 0.45; while at the same time, the quantity (f+g) may be up to 0.57, alternatively up to 0.52, alternatively up to 0.49, alternatively up to 0.47, and alternatively up to 0.45. Alternatively, the quantity (f+g) may have a value such that 0.02≤(f+g)≤0.57; alternatively 0.20≤(f+g)≤0.57; alternatively 0.30≤(f+g)≤0.57; alternatively 0.40≤(f+g)≤0.57; alternatively 0.43≤(f+g)≤0.52; and alternatively 0.40≤(f+g)≤0.49.

In the group of formula (I) above, subscript a, b, and x each represent an integer. Subscript a is 1 or 2, alternatively, subscript a may be 1. Subscript b is 0 or 1. Alternatively, subscript b may be 0. Alternatively, subscript b may be 1. Subscript x is 0 or 1. Alternatively, subscript x may be 0.

In the group of formula (I) above, each alkyl group, R¹, is independently selected, and may be an alkyl group as described above for Z. Alternatively, each R¹ may be methyl.

In the group of formula (I) above, each D¹ is an independently selected alkylene group. D¹ may have empirical formula —CₕH₂ₕ—, where subscript h is at least 2, alternatively 2 to 12, alternatively 2 to 10, alternatively 2 to 8, alternatively 2 to 6, alternatively 2 to 4, and alternatively 2 to 3. Alternatively, each D¹ may be ethylene, propylene, or hexylene.

Alternatively, each D¹ may be —C₂H₄—, such as ethylene.

The alkoxy-functional silsesquioxane resin may be, alternatively is, free of tetrafunctional siloxane units of formula (SiO_{4/2}). The alkoxy-functional silsesquioxane resin is in a liquid state at RT and ambient pressure (e.g., 101.325 kPa) (e.g., by visual inspection). Alternatively, the alkoxy-functional silsesquioxane resin may have Mn of 1,300 g/mol to 4,000 g/mol; alternatively 1,400 g/mol to 3,500 g/mol, and alternatively 2,000 g/mol to 2,500 g/mol. Alternatively, the alkoxy-functional silsesquioxane resin may have Mw of 1,000 g/mol to 50,000 g/mol; alternatively 2,000 g/mol to 50,000 g/mol; alternatively 2,500 g/mol to 40,000 g/mol; alternatively 4,000 to 10,000 g/mol; and alternatively 1,000 g/mol to 15,000 g/mol; and PDI of 2 to 4, alternatively 2.3 to 3.9.

### Methods for Preparing the Resin

The alkoxy-functional silsesquioxane resin described above may be prepared via a hydrosilylation reaction process. The process comprises: 1) combining, under conditions to effect hydrosilylation reaction, starting materials comprising: A) an alkoxy-functional organosilicon compound and B) a silsesquioxane resin in the presence of C) a hydrosilylation reaction catalyst. Starting material D), a solvent, may optionally be used to facilitate mixing and/or delivery of one or more of the starting materials. For example, C) the hydrosilylation reaction catalyst may be dissolved or dispersed in D) the solvent before combining with starting materials A) and B). Starting material A), the alkoxy-functional organosilicon compound, may comprise a silicon bonded hydrogen atom when B) the silsesquioxane resin comprises a silicon bonded aliphatically unsaturated group. Alternatively, A) the alkoxy-functional organosilicon compound may comprise an aliphatically unsaturated group when B) the silsesquioxane resin comprises a silicon bonded hydrogen atom.

Starting material C) is a hydrosilylation reaction catalyst. The hydrosilylation reaction catalyst comprises a platinum group metal. The platinum group metal may be selected from the group consisting of platinum, rhodium, ruthenium, palladium, osmium, and iridium. Alternatively, the platinum group metal may be platinum. The hydrosilylation reaction catalyst may be the platinum group metal or a compound or complex of the platinum group metal. For example, the hydrosilylation reaction catalyst may be a compound such as chloridotris(triphenylphosphane)rhodium(I) (Wilkinson's Catalyst), a rhodium diphosphine chelate such as [1,2-bis(diphenylphosphino)ethane]dichlorodirhodium or [1,2-bis(diethylphospino)ethane]dichlorodirhodium, chloroplatinic acid (Speier's Catalyst), chloroplatinic acid hexahydrate, platinum dichloride, or a complex of such a compound with an alkenyl-functional organopolysiloxane such as 1,3-diethenyl-1,1,3,3-tetramethyldisiloxane complexes with platinum (Karstedt's Catalyst) or Pt(0) complex in tetramethyltetravinylcyclotetrasiloxane (Ashby's Catalyst). Alternatively, the compound or complex may be microencapsulated in a matrix or coreshell type structure. Hydrosilylation reaction catalysts are known in the art, for example, as described in PCT Patent Application Publication WO2021/081822 to Guo, et al. and the references cited therein. Hydrosilylation reaction catalysts are commercially available, for example, SYL-OFF™ 4000 Catalyst and SYL-OFF™ 2700 are available from Dow. The amount of C) the hydrosilylation reaction catalyst depends on various factors including the types and amounts of starting materials A) and B), and their respective contents of silicon bonded hydrogen atoms and aliphatically unsaturated groups, however the amount of C) the hydrosilylation reaction catalyst is sufficient to catalyze the hydrosilylation reaction and may be, for example, an amount sufficient to provide at least 1 ppm of the platinum group metal based on combined weights of starting materials A), B), and C), while at the same time the amount may be sufficient to provide up to 6,000 ppm of the platinum group metal, on the same basis. Alternatively, the amount of starting material C) may be sufficient to provide 1 ppm to 1,000 ppm; alternatively 1 ppm to 100 ppm; alternatively 1 ppm to 50 ppm; alternatively 1 ppm to 25 ppm, and alternatively 1 ppm to 15 ppm, of the platinum group metal on the same basis.

Starting material D) is an optional solvent that may be used to deliver one or more of the starting materials. The solvent may be added facilitate introduction of certain starting materials, such as C) the hydrosilylation reaction catalyst. Solvents that can be used herein are those that help fluidize the starting materials, but essentially do not react with the starting materials. The solvent may be selected based on solubility the starting materials and volatility of the solvent. The solubility refers to the solvent being sufficient to dissolve and/or disperse a starting material. Volatility refers to vapor pressure of the solvent.

Suitable solvents include polyorganosiloxanes with suitable vapor pressures, such as hexamethyldisiloxane, octamethyltrisiloxane, hexamethylcyclotrisiloxane and other low polyorganosiloxanes, such as polydimethylsiloxanes, e.g., 0.5 to 1.5 cSt DOWSIL™ 200 Fluids and DOWSIL™ OS FLUIDS, which are commercially available from Dow.

Alternatively, the solvent may comprise an organic solvent. The organic solvent can be an alcohol such as methanol, ethanol, isopropanol, butanol, or n-propanol; an aromatic hydrocarbon such as benzene, toluene, ethylbenzene or xylene; an aliphatic hydrocarbon such as heptane, hexane, or octane; a halogenated hydrocarbon such as dichloromethane, 1,1,1-trichloroethane or methylene chloride; or a combination thereof.

The amount of D) the solvent will depend on various factors including the type of solvent selected and the amount and type of other starting materials selected for the composition. However, the amount of solvent may range from 1 weight % to 99 weight %, alternatively 2 weight % to 90 weight %, based on combined weights of starting materials A), B) and C).

The hydrosilylation reaction process may be performed by any convenient means, such as combining starting materials A), B), and C), and when present D). Typically, starting materials A) and B) are combined in a reactor. When the reaction is carried out at an elevated or reduced temperature as described below, the reactor may be heated or cooled in any suitable manner, e.g. via a jacket, mantle, exchanger, bath, or coils. Starting materials A), B), and C), and optionally D), may be fed together or separately to the reactor, or may be disposed in the reactor in any order of addition, and in any combination. For example, starting materials A) and C), and optionally D), may be added to a reactor, and starting material B) may be added thereto in one aliquot, alternatively starting material B) may be metered into the reactor continuously, or intermittently in two or more aliquots. Alternatively, starting materials B) and C), and optionally D), may be added to a reactor, and starting material A) may be added thereto in one aliquot, alternatively, starting material A) may be metered into the reactor continuously or intermittently in two or more aliquots. Order of addition may depend on various factors including which starting materials have silicon bonded hydrogen atoms.

Alternatively, starting materials A), B), and optionally D) may be first combined prior to the addition, or may be added to the vessel sequentially, and thereafter starting material C) may be added to the vessel containing starting materials A) and B), and optionally D). In general, reference to the “reaction mixture” herein refers generally to a mixture comprising starting materials A), B), and C), and optionally D), (e.g. as obtained by combining such starting materials, as described above).

The amounts of starting materials A) and B) are not restricted, and may be any amount sufficient to provide the content of groups of formula (I) in the alkoxy-functional silsesquioxane resin described above.

Step 1) of the process may further comprise agitating the reaction mixture. The agitating may enhance mixing and contacting together starting materials A), B), and C), and when present D), when combined, e.g. in the reaction mixture thereof. Such contacting independently may use other conditions, with (e.g. concurrently or sequentially) or without (i.e., independent from, alternatively in place of) the agitating. The other conditions may be tailored to enhance the contacting, and thus reactions (i.e., isomerization and hydrosilylation), of starting materials A) and B) to form the reaction product comprising the organosilicon compound.

Step 1) of the process may further comprise heating the reaction mixture. The temperature depends on various factors including the vapor pressures of starting materials A) and B), and when present D), however the temperature may be 50° C. to 150° C., alternatively 60° C. to 100° C.

The process described herein may optionally further comprise one or more additional steps. For example, the process may further comprise step 2): purifying the hydrosilylation reaction product, e.g., to remove and/or recover unreacted starting materials. Purifying may be performed by any convenient means such as stripping and/or distillation with heating and optionally under reduced pressure and/or azeotroping with solvents, filtration, and combinations thereof. The distillation conditions typically include: (i) an elevated temperature; (ii) a reduced pressure; or (iii) both an elevated temperature and reduced pressure. By elevated or reduced, it is meant as compared to room temperature and atmospheric pressure. The distillation may be continuous or batch, and may include use of a solvent (e.g. hexane, or toluene, or other solvent describe herein as starting material D)), such that the distillation may be an azeotropic distillation.

As used herein, purifying hydrosilylation reaction product is typically defined as increasing the relative concentration of the alkoxy-functional silsesquioxane resin as compared to other compounds in combination therewith (e.g. in the hydrosilylation reaction product or a purified version thereof). As is understood in the art, purifying may comprise removing the other compounds from such a combination (i.e., decreasing the amount of impurities and/or unreacted starting materials combined with the alkoxy-functional silsesquioxane resin in the hydrosilylation reaction product) and/or removing the alkoxy-functional silsesquioxane resin itself from the combination. Any suitable technique and/or protocol for purification may be used. Examples of suitable purification techniques include distilling, stripping, evaporating, extracting, filtering, washing, partitioning, phase separating, adsorption, and chromatography. As will be understood by those of skill in the art, any of these techniques may be used in combination (e.g., sequentially) with any another technique to purify the hydrosilylation reaction product. Regardless of the particular technique(s) selected, purifying the hydrosilylation reaction product may be performed in sequence (i.e., in line) with the hydrosilylation reaction itself, and thus may be automated. Alternatively, purifying may be a stand-alone procedure to which the hydrosilylation reaction product comprising the organosilicon compound is subjected.

For example, when A) the alkoxy-functional organosilicon compound has the silicon bonded hydrogen atom, and B) the silsesquioxane resin has the aliphatically unsaturated group, the process for preparing the alkoxy-functional silsesquioxane resin described above may comprise:
1) combining, under conditions to effect hydrosilylation reaction, starting materials comprising
   A1) an alkoxy-functional organohydrogensiloxane oligomer of formula:

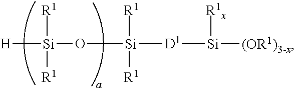

a where R¹, D¹, a, and x are as described above; and
B1) an alkenyl-functional silsesquioxane resin of unit formula
   (R³₃SiO_{1/2})_{c}(R³₂SiO_{2/2})_{d}(R³SiO_{3/2})ₑ(ZO_{1/2})_{f}(HO_{1/2})g, where Z, c, d, e, f, and g are as described above and
   each R³ is independently selected from the group consisting of an alkyl group and an alkenyl group,
      with the proviso that at least one R³, per molecule, is an alkenyl group;
in the presence of C) the hydrosilylation reaction catalyst described above; and optionally D) the solvent described above. The optional additional steps are as described above.

Starting material A1) is an alkoxy-functional organohydrogensiloxane oligomer of formula: A1) an alkoxy-functional organohydrogensiloxane oligomer of formula:

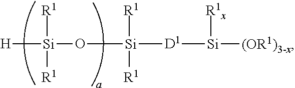

where R¹, D¹, a, and x are as described above. Alternatively, the alkoxy-functional organohydrogensiloxane oligomer may have subscript a=1, and subscript x=0. Alternatively, in the formula for A1) the alkoxy-functional organohydrogensiloxane oligomer, each R¹=methyl, each D¹ may have empirical formula —C₂H₄—. Alternatively, the alkoxy-functional organohydrogensiloxane oligomer may be trimethoxysilylethyl-1,1,3,3,5,5-hexamethyltrisiloxane; trimethoxysilylethyl-1,1,3,3-tetramethyldisiloxane; or a combination thereof. Alkoxy-functional organohydrogensiloxane oligomers of the formula shown above are known in the art and may be made by known methods, such as those described in U.S. Pat. No. 10,968,317 to Gohndrone, et al; U.S. Pat. No. 11,098,163 to Gohndrone, et al; U.S. Pat. No. 11,161,939 to Zhou, et al.; U.S. Pat. No. 11,168,181 to Zhou, et al.; and 11,492,448 to Gohndrone, et al; and JP2007077136 to Uehara, et al.

Starting material B1) is a silsesquioxane resin an alkenyl-functional silsesquioxane resin of unit formula (R³₃SiO_{1/2})_{c}(R³₂SiO_{2/2})_{d}(R³SiO_{3/2})ₑ(ZO_{1/2})_{f}; where Z, c, d, e, and f are as described above, and each R³ is independently selected from the group consisting of an alkyl group and an alkenyl group capable of undergoing hydrosilylation reaction, with the proviso that at least one R³, per molecule, is an alkenyl group. Examples of suitable alkenyl groups may have 2 to 12, alternatively 2 to 10, alternatively 2 to 8, and alternatively 2 to 6 carbon atoms. The alkenyl groups are capable of undergoing a hydrosilylation reaction with a silicon bonded hydrogen atom. Suitable alkenyl groups for R³ are exemplified by vinyl, allyl, and hexenyl; alternatively vinyl and hexenyl; and alternatively vinyl.

Starting material B1) can be prepared by known methods, such as co-hydrolyzing organosilanes having, per molecule, three hydrolyzable moieties, such as halogen or alkoxy, bonded to silicon atoms. For example, starting material B1) may be prepared by the process described in U.S. Pat. No. 11,248,119 by varying the starting materials and amounts thereof. Starting material B1) can be obtained, for example, by co-hydrolyzing methyltrimethoxysilane and vinyltrimethoxysilane, optionally with additional silanes such as octyltriethoxysilane and octyltrimethoxysilane. Alkoxysilanes with two alkoxy groups per molecule or 1 alkoxy group per molecule, such as dimethyldimethoxysilane or trimethylmethoxysilane may be included to add difunctional and/or monofunctional siloxane units to the silsesquioxane resin, respectively. An acid catalyst, such as triflic acid, water, and/or an alcohol may be used to facilitate co-hydrolysis.

Alternatively, when A) the alkoxy-functional organosilicon compound has the aliphatically unsaturated group and B) the silsesquioxane resin has the silicon bonded hydrogen atom, the process for preparing the alkoxy-functional silsesquioxane resin of described above may comprise:
1) combining, under conditions to effect hydrosilylation reaction, starting materials comprising
   A2) an alkoxy-functional organosilicon compound of formula R¹ₓR⁵Si(OR¹)₃₋ₓ, where R¹ and x are as described above, and R⁵ is an alkenyl group capable of undergoing hydrosilylation reaction; and
   B2) a hydrido-functional silsesquioxane resin of unit formula
      (R⁴₃SiO_{1/2})_{c}(R⁴₂SiO_{2/2})_{d}(R⁴SiO_{3/2})ₑ(ZO_{1/2})_{f}; where Z, c, d, e, and f are as described above and each R⁴ is independently selected from the group consisting of an alkyl group and H, with the proviso that at least one R⁴, per molecule, is H;
   in the presence of C) the hydrosilylation reaction catalyst, described above, and
   optionally D) the solvent, described above.

Starting material A2) is an alkoxy-functional organosilicon compound, which has at least one alkenyl group per molecule. The alkoxy-functional organosilicon compound may be an alkoxy-functional silane of formula R¹ₓR⁵Si(OR¹)₃₋ₓ, where R¹ and x are as described above, and R⁵ is an alkenyl group capable of undergoing hydrosilylation reaction. Examples of suitable alkenyl groups may have 2 to 12, alternatively 2 to 10, alternatively 2 to 8, and alternatively 2 to 6 carbon atoms. The alkenyl groups are capable of undergoing a hydrosilylation reaction with a silicon bonded hydrogen atom. Suitable alkenyl groups for R⁵ are exemplified by vinyl, allyl, and hexenyl; alternatively vinyl and hexenyl; and alternatively vinyl. Suitable alkoxy-functional silanes for starting material A2) are known in the art and are commercially available. For example, alkenyl-functional trialkoxysilanes such as allyltrimethoxysilane, vinyltrimethoxysilane, vinyltriethoxysilane, vinyltriisopropoxysilane, and vinyltris(methoxyethoxy)silane; alkenyl-functional dialkoxysilanes such as vinylphenyldiethoxysilane, vinylmethyldimethoxysilane, and vinylmethyldiethoxysilane; alkenyl-functional monoalkoxysilanes such as trivinylmethoxysilane are all available from Gelest, Inc. of Morrisville, Pennsylvania, USA.

Starting material B2) is hydrido-functional silsesquioxane resin of unit formula (R⁴₃SiO_{1/2})_{c}(R⁴₂SiO_{2/2})_{d}(R⁴SiO_{3/2})ₑ(ZO_{1/2})_{f}; where Z, c, d, e, and f are as described above and each R⁴ is independently selected from the group consisting of an alkyl group and H, with the proviso that at least one R⁴, per molecule, is H. Starting material B2) may be prepared by known methods, such as those described above for starting material B1) by substituting appropriate starting materials, such as hydrido-functional alkoxysilanes for alkenyl-functional alkoxysilanes. For example, starting material B2) may be prepared by the process described in U.S. Pat. No. 11,248,119 by varying the starting materials and amounts thereof.

The product of these processes is the alkoxy-functional silsesquioxane resin, described above. The alkoxy-functional silsesquioxane resin is useful in curable compositions, such as coating compositions, e.g., conformal coating compositions.

### Moisture Curable Composition

The alkoxy-functional silsesquioxane resin prepared as described above may be used in a moisture curable composition, such as a coating composition. For example, the alkoxy-functional silsesquioxane resin described herein may be used in a moisture curable (polyorganosiloxane) composition for electric/electronic apparatus, such as that described in U.S. Patent Application Publication 2021/0238444, where the alkoxy-functional silsesquioxane resin described herein is used in addition to, or instead of, the resin described in U.S. Patent Application Publication 2021/0238444.

The moisture curable composition may comprise: 1) the alkoxy-functional silsesquioxane resin described above, and II) a condensation reaction catalyst.

Starting material II) is a condensation-reaction catalyst. Examples of II) the condensation reaction catalyst include, but are not limited to: tin compounds such as dimethyltin dineodecanoate, and stannous octoate; and titanium compounds such as tetra(isopropoxy)titanium; tetra(n-butoxy)titanium and tetra(t-butoxy)titanium; and organic titanium chelates such as di(isopropoxy)bis(ethylacetoacetate)titanium; di(isopropoxy)bis(methylacetoacetate)titanium; di(isopropoxy)bis(acetylacetonate)titanium; and bis(ethylacetoacetato-O1′, O3″)bis(propan-2-olato) titanium. Condensation reaction catalysts are known in the art and are commercially available. For example organic titanates and zirconates are commercially available from Dorf Ketal under the tradename TYZOR™.

The content of starting material II) is not limited, provided that it is an amount that can impart sufficient curability to the moisture curable composition. For example, the content of starting material II) may be 0.01 parts by weight to 20 parts by weight, alternatively 0.01 parts by weight to 15 parts by weight, alternatively 0.01 parts by weight to 10 parts by weight, alternatively 0.01 parts by weight to 5 parts by weight, alternatively 0.01 parts by weight to 1 parts by weight, alternatively 0.05 parts by weight to 10 parts by weight, or alternatively 0.05 parts by weight to 5 by weight, relative to 100 parts by weight of contents of starting materials I) and II) combined. Without wishing to be bound by theory, it is thought that when the content of II) the condensation reaction catalyst is greater than or equal to the lower limit of the range described above, the resulting composition cures sufficiently by moisture in air, and when the content is less than or equal to the upper limit of the range described above, surface cure rate of the resulting composition may be improved.

The moisture curable composition may optionally further comprise one or more additional starting materials (i.e., in addition to I) the alkoxy-functional silsesquioxane resin, and II) the condensation reaction catalyst described above). For example, the composition may further comprise at least one of III) a solvent, IV) an alkoxysilane, V) a fluorescent whitening agent and/or a UV indicator, VI) a corrosion inhibitor, VII) a chelating agent, VIII) an adhesion promoter, and IX) a combination of two or more of III) to VIII).

Starting material III) is a solvent, which may be a solvent as described above for starting material D). Alternatively, examples of suitable solvents for use in the moisture curable composition include, but are not limited to: aliphatic hydrocarbon solvents such as heptane, octane, nonane, decane, and undecane; and siloxane-type solvents such as straight dimethylsiloxane oligomers (described above), cyclic dimethylsiloxane oligomers, and tetrakis (trimethylsiloxy) silane.

The content of 111) the solvent is not limited, provided that it is an amount that coating performance of the resulting moisture curable composition is improved. When present, the content of III) the solvent may be 0.1 parts by weight to 50 parts by weight, alternatively 0.1 parts by weight to 30 parts by weight, alternatively 0.1 parts by weight to 20 parts by weight, alternatively 0.1 parts by weight to 15 parts by weight, or alternatively 0.1 parts by weight to 10 parts by weight, relative to 100 parts by weight of the contents of starting materials I) and II) combined. Alternatively, the moisture curable composition may be substantially free of organic solvent. As used herein, “substantially free of organic solvent” means that organic solvent is not intentionally added to the moisture curable composition, however, this does not exclude residual solvent present in one or more of the other starting materials used in the moisture curable composition. For example, the moisture curable composition may contain no organic solvent. Alternatively, the moisture curable composition may contain a non-detectable amount of organic solvent by gas chromatography. Alternatively, the moisture curable composition may contain up to 100 ppm of organic solvent, which is residual in the starting materials used to prepare the moisture curable composition.

Starting material IV) is an alkoxysilane, which may be represented by the general formula: R⁶ᵢ Si(OR⁷)₍₄₋ᵢ₎, where R⁶ is a monovalent hydrocarbon group, R⁷ is an alkyl group, and subscript i is an integer. In the formula for the alkoxysilane, R⁶ is a monovalent hydrocarbon group. Examples of such groups include, but are not limited to: alkyl groups such as those described above for Z; alkenyl groups such as vinyl, allyl, butenyl, pentenyl, hexenyl, heptenyl, octenyl, nonenyl, decenyl, and octadecenyl; aryl groups such as phenyl, tolyl, xylyl, naphthyl, benzyl, phenethyl, and phenylpropyl. Alternatively, each R⁶ may be independently selected from an alkyl group or alkenyl group. Alternatively, each R⁶ may be independently selected from methyl or vinyl. Each R⁷ is an independently selected alkyl group. Examples of such groups include the alkyl groups described above for Z. Alternatively, each R⁷ may be independently selected from methyl or ethyl. Subscript i is an integer with a value of 0 to 2, alternatively 1 or 2.

Examples of IV) the alkoxysilane include, but are not limited to: dimethyldimethoxysilane, methyltrimethoxysilane, methylphenyldimethoxysilane, and dimethyldiethoxysilane. Starting material IV) may be one of these alkoxysilanes or a combination of two or more. Alternatively, starting material IV) may comprise, or may be dimethyldimethoxysilane and/or methyltrimethoxysilane. Alkoxysilanes such as these are known in the art and are commercially available as described above with respect to starting materials B1) and B2). Alternatively, alkoxysilanes and condensation reaction catalysts may be commercially available as moisture cure packages, such as under the tradename TYZOR™ from Dorf Ketal.

The content of IV) the alkoxysilane is not limited provided that it is an amount that can impart sufficient shelf life of the resulting composition. Alternatively, the content of IV) the alkoxysilane may be 0.5 parts by weight to 20 parts by weight, alternatively 1 parts by weight to 20 parts by weight, alternatively 1 parts by weight to 15 parts by weight, or alternatively 0.5 parts by weight to 10 parts by weight, relative to 100 parts by weight of the contents of starting materials I) and II) combined. Without wishing to be bound by theory, it is thought that when the content of IV) the alkoxysilane is greater than or equal to the lower limit of the range described above, the resulting moisture curable composition cures rapidly by moisture in air, and when the content is less than or equal to the upper limit of the range described above, the curability of the resulting moisture curable composition is sufficient, and the shelf life of said composition under moisture blocking is improved.

Starting material V) is a fluorescent whitening agent and/or a UV indicator, which may be a molecule that fluoresces under irradiation with 365 nm and/or 405 nm light. Examples of the fluorescent whitening agents include, but are not limited to: benzoxazole derivatives such as 2,5-bis(benzo[d]oxazol-2-yl)thiophene derivatives, such as 2,5-bis(5-(tert-butyl)benzo[d]oxazol-2-yl)thiophene, which are commercially available under the trade name TINOPAL OB from BASF; diaminostilbene-sulphonic acid derivatives such as disodium salt of 4,4′-bis-(2-morpholino-4 anilino-s-triazin-6-ylamino) stilbene disulphonate, which are commercially available under the trade name Tinopal DMS from Ciba-Geigy AG; and bisphenyl-distyryl derivatives such as disodium salt of 2,2′-bis-(phenyl-styryl) disulphonate, which are commercially available under the trade name Tinopal CBS from Ciba-Geigy AG; and diarylpyrazoline derivatives. Exemplary 2,5-bis(benzo[d]oxazol-2-yl)thiophene derivatives may have general formula:

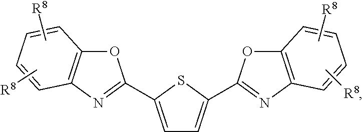

where each R⁸ is independently selected from the group consisting of H and an alkyl group of 1 to 30 carbon atoms.

The content of the starting material V) in the moisture curable composition is not limited provided that it is an amount that visibility of a coating prepared with the moisture curable composition is improved under UV light exposure as compared to a coating made with the same moisture curable composition, except with starting material V) omitted. For example, the content of starting material V) may be 0.001 parts by weight to 0.1 parts by weight, alternatively 0.005 parts by weight to 0.1 parts by weight, or alternatively 0.005 parts by weight to 0.05 parts by weight, relative to 100 parts by weight of the contents of starting materials I) and II) combined.

Starting material VI) is a corrosion inhibitor. Examples of the corrosion inhibitors include, but are not limited to; 1H-1,2,3-triazole, 2H-1,2,3-triazole, 1H-1,2,4-triazole, 4H-1,2,4-triazole, 2-(2′-hydroxy-5′-methylphenyl)benzotriazole, 1H-1,2,3-triazole, 2H-1,2,3-triazole, 1H-1,2,4-triazole, 4H-1,2,4-triazole, benzotriazole, tolyltriazole, carboxybenzotriazole, 1H-benzotriazole-5-methylcarboxylate, 3-amino-1,2,4-triazole, 4-amino-1,2,4-triazole, 5-amino-1,2,4-triazole, 3-mercapto-1,2,4-triazole, chlorobenzotriazole, nitrobenzotriazole, aminobenzotriazole, cyclohexano[1,2-d]triazole, 4,5,6,7-tetrahydroxytolyltriazole, 1-hydroxybenzotriazole, ethylbenzotriazole, naphthotriazole, 1-N,N-bis(2-ethylhexyl)-[(1,2,4-triazole-1-yl)methyl]amine, 1-[N,N-bis(2-ethylhexyl)aminomethyl]benzotriazole, 1-[N,N-bis(2-ethylhexyl)aminomethyl]tolyltriazole, 1-[N,N-bis(2-ethylhexyl)aminomethyl]carboxybenzotriazole, 1-[N,N-bis(2-hydroxyethyl)-aminomethyl]benzotriazole, 1-[N,N-bis(2-hydroxyethyl)-aminomethyl]tolyltriazole, 1-[N,N-bis(2-hydroxyethyl)-aminomethyl]carboxybenzotriazole, 1-[N,N-bis(2-hydroxypropyl)aminomethyl]carboxybenzotriazole, 1-[N,N-bis(1-butyl)aminomethyl]carboxybenzotriazole, 1-[N,N-bis(1-octyl)aminomethyl]carboxybenzotriazole, 1-(2′,3′-di-hydroxypropyl)benzotriazole, 1-(2′,3′-di-carboxyethyl)benzotriazole, 2-(2′-hydroxy-3′,5′-di-tert-butylphenyl)benzotriazole, 2-(2′-hydroxy-3′,5′-amylphenyl)benzotriazole, 2-(2′-hydroxy-4′-octoxyphenyl)benzotriazole, 2-(2′-hydroxy-5′-tert-butylphenyl)benzotriazole, 1-hydroxybenzotriazole-6-carboxylic acid, 1-oleoylbenzotriazole, 1,2,4-triazol-3-ol, 5-amino-3-mercapto-1,2,4-triazole, 5-amino-1,2,4-triazole-3-carboxylic acid, 1,2,4-triazole-3-carboxyamide, 4-aminourazole, and 1,2,4-triazol-5-one.

The content of the corrosion inhibitor is not limited provided that it is an amount that can suppress corrosion of substrates covered with a cured product of the resulting moisture curable composition. The content of the corrosion inhibitor may be 0.01 ppm to about 3 weight % of the composition.

Starting material VII) is a chelating agent. Examples of the chelating agent include, but are not limited to: alpha-substituted aceto-acetic esters such as methylacetoacetate, ethylacetoacetate. The content of the chelating agent is not limited provided that it is an amount that can impart sufficient stability of the resulting moisture curable composition. For example, the content of the chelating agent may be 0.01 to 20 parts by mass, alternatively 0.01 to 15 parts by mass, relative to 100 parts by mass of the total amount of starting materials I) and II).

Starting material VIII) is an adhesion promoter. Examples of the adhesion promoter include, but are not limited to: epoxy group-containing alkoxysilanes such as 3-glycidoxytrimethoxysilane, 3-glycidoxypropyltriethoxysilane, 3-glycidoxypropylmethoxysilane, 2-(3,4-epoxycyclohexyl)ethyltrimethoxysilane, and 4-oxysilanylbutyltrimethoxysilane; acrylic group-containing alkoxysilanes such as 3-methacryloxypropyltrimethoxysilane, 3-methacryloxypropyltriethoxysilane, and 3-acryloxypropyltrimethoxysilane; amino group-containing alkoxysilanes such as 3-aminopropyltrimethoxysilane, 3-aminopropyltriethoxysilane, N-(2-aminoethyl)-3-aminopropyltrimethoxysilane, and N-phenyl-3-aminopropyltrimethoxysilane; and reaction mixtures of the above epoxy group-containing alkoxysilanes and the above amino group-containing alkoxysilanes. Alternatively, the adhesion promoter comprises, or is, selected from reaction mixtures of the above epoxy group-containing alkoxysilanes and the above amino group-containing alkoxysilanes. Adhesion promoters are known in the art and are commercially available, such as DOWSIL™ Z-6011 Silane, DOWSIL™ Z-6121 Silane, DOWSIL™ Z-6137 Silane, XIAMETER™ OFS-6011 Silane, and XIAMETER™ OFS-6610 SILANE, all of which are available from Dow.

The content of the adhesion promoter in the moisture curable composition is not limited provided that it is an amount that can impart sufficient adhesion to various substrates that the composition contacts during curing. For example, the content of the adhesion promoter may be 0.01 parts by weight to 10 parts by weight, or alternatively 0.01 parts by weight to 5 parts by weight, relative to 100 parts by weight of the contents of starting materials I) and II) combined.

The moisture curable composition may be prepared by any convenient means, such as mixing starting materials comprising I) the alkoxy-functional silsesquioxane resin and II) the condensation reaction catalyst, and any optional additional starting materials, in the amounts and as described above at RT. The starting materials may be combined and mixed in any order. In a one part composition, the starting materials may be mixed under anhydrous conditions. Alternatively, the moisture curable composition may be prepared in a multiple part kit, such as a two part kit. For example, the two part kit may comprise a base part and a curing agent part, and optionally instructions mixing the base part and the curing agent part before use. The base part may comprise I) the alkoxy-functional silsesquioxane resin and one or more of the additional starting materials. The curing agent part may comprise II) the condensation reaction catalyst and one or more of the additional starting materials, such as IV) the alkoxysilane. The base part and the curing agent part may each be prepared by any convenient means, under anhydrous or ambient conditions. The base part and curing agent part may be combined by any convenient means, such as mixing, shortly before use. The base part and curing agent part may be combined in relative amounts of base: curing agent ranging from 1:1 to 10:1.

The equipment used for mixing the starting materials of the moisture curable composition is not specifically restricted. Examples of suitable mixing equipment may be selected depending on the type and amount of each starting material selected. For example, agitated batch kettles may be used for relatively low viscosity compositions. Alternatively, continuous compounding equipment, e.g., extruders such as twin screw extruders, may be used for more viscous compositions. Exemplary methods that can be used to prepare the moisture curable composition described herein include those disclosed in, for example, U.S. Patent Application Publications US 2009/0291238 and US 2008/0300358.

A method of preparing a film with the moisture curable is provided. The method of preparing the film comprises applying the moisture curable composition on a substrate. The method further comprises forming the film on the substrate.

The method by which the moisture curable is applied on the substrate may vary. For example, the step of applying the moisture curable composition on the substrate may use a wet coating application method. Specific examples of wet coating application methods suitable for the method include dip coating, spin coating, flow coating, spray coating, roll coating, gravure coating, sputtering, slot coating, inkjet printing, and combinations thereof.

The substrate is not limited and may be any material, and may be continuous or discontinuous and may have any size, shape, dimension, and surface roughness. In certain embodiments, the substrate comprises a plastic, which maybe a thermosetting and/or thermoplastic. However, the substrate may alternatively be glass, metal, paper, wood, a silicone, or other materials, or a combination thereof. Alternatively, the substrate may be all, or a portion, of an electric/electronic device.

Typically, applying the moisture curable composition on the substrate results in a wet film on the substrate, and forming the film on the substrate comprises drying the wet film on the substrate to form the film. For example, drying the wet film may comprise: optionally (i) evaporating solvent from the wet film (when solvent is present); optionally (ii) exposing the wet film to an elevated temperature to drive solvent therefrom (when solvent is present); and (iii) curing the wet film. Curing the wet film may occur via exposure to atmospheric moisture. Without wishing to be bound by theory, it is thought that alkoxy groups from the alkoxy-functional silsesquioxane resin, may react (e.g. cure) such that the film is the reaction product of the alkoxy-functional silsesquioxane resin and optionally one or more additional starting materials in the moisture curable composition.

The film may be separable from the substrate (e.g. peelable) or may be physically and/or chemically bonded to the substrate. The substrate may have an integrated hot plate or an integrated or stand-alone furnace for drying/curing the deposit. The substrate may optionally have a continuous or non-continuous shape, size, dimension, surface roughness, and other characteristics. Alternatively, the substrate may have a softening point temperature at the elevated temperature. However, the moisture curable composition and method are not so limited.

Typically, forming the film comprises exposing the wet film to an elevated temperature for a period of time. The elevated temperature is typically from 50° C. to 250° C., alternatively from 100° C. to 200° C., alternatively from 110° C. to 190° C., alternatively from 120° C. to 180° C., alternatively from 130° C. to 170° C., alternatively from 140° C. to 160° C., alternatively from 145° C. to 155° C. The period of time is typically sufficient to effect drying and/or curing, or at least curing (e.g. cross-linking) the alkoxy-functional silsesquioxane resin. The period of time may be >0 to 10, alternatively >0 to 5, alternatively >0 to 2, hours. The period of time may be broken down into dry/cure iterations, e.g. a first-cure and a post-cure, with the first-cure being, for example, one hour and the post-cure being, for example, one hour. The elevated temperature may be independently selected in such iterations, and may be the same in each iteration. Alternatively, the film may be formed by merely exposing the wet film to ambient conditions, i.e., drying at RT in the presence of atmospheric moisture and in the absence of any elevated temperature.

Depending on a thickness and other dimensions of the film, the film could also be formed via an iterative process. For example, a first deposit may be formed and optionally subjected to a first elevated temperature for a first period of time to give a partially dried and/or cured deposit. Then, a second deposit may be disposed on the first deposit or the partially dried and/or cured deposit and optionally subjected to a second elevated temperature for a second period of time to give a second partially dried/cured deposit. This process may be repeated, for example, from 1 to 50 times to build the film as desired. Each elevated temperature and period of time may be independently selected and may be the same as or different from one another. The iterative process may be wet-on-wet. Alternatively, the iterative process may be wet-on-dry, depending on a dry/cure state of the partially dried and/or cured deposit.

The film may have a thickness which varies depending upon its end use application. Typically, the film has a thickness of >0 to 4,000 μm, alternatively >0 to 3,000 μm, alternatively >0 to 2,000 μm, alternatively >0 to 1,000 μm, alternatively >0 to 500 μm, alternatively >0 to 250 μm, alternatively >0 to 100 μm, alternatively 1 to 50 μm, alternatively 20 to 30 μm. However, other thicknesses are contemplated, e.g. 0.1 to 200 μm. For example, the thickness of the film may be from 0.2 to 175 μm; alternatively from 0.5 to 150 μm; alternatively from 0.75 to 100 μm; alternatively from 1 to 75 μm; alternatively from 2 to 60 μm; alternatively from 3 to 50 μm; alternatively from 4 to 40 μm; alternatively any one of 1, 2, 3, 4, 5, 6, 7, 8, 9, 10, 15, 20, 25, 30, 35, 40, 45, 50, 60, 70, 75, 80, 90, 100, 150, 175, and 200 μm.

Independent of the method by which the film is formed, once the film is formed on the substrate from the emulsion and/or the composition, the film may further undergo post processing such as heating, humidification, catalytic post treatment, photoirradiation, or electron beam irradiation.

If desired, the film may be subjected to further processing depending upon its end use application. For example, the film may be subjected to oxide deposition (e.g. SiO₂ deposition), resist deposition and patterning, etching, chemical or plasma stripping, metallization, or metal deposition. Such further processing techniques are generally known. Such deposition may be chemical vapor deposition (including low-pressure chemical vapor deposition, plasma-enhanced chemical vapor deposition, and plasma-assisted chemical vapor deposition), physical vapor deposition, or other vacuum deposition techniques. Many such further processing techniques involve elevated temperatures, particularly vacuum deposition, for which the film is well suited in view of its excellent thermal stability. Depending on an end use of the film, however, the film may be utilized without such further processing.

Alternatively, the substrate may comprise an electric/electronic apparatus. A coated electric/electronic apparatus may be obtained by using the moisture curable composition described above. The electric/electronic apparatus is not particularly limited, but is exemplified by electric/electronic apparatuses that contain electrical circuits and/or electrodes. It is thought that such coated electric/electronic apparatuses have good to excellent reliability due to good to excellent adhesion to the substrate contacted during curing of the moisture curable composition, and/or good to excellent thermal shock stability.

### Examples

The following examples are provided to illustrate the invention to those skilled in the art and are not to be construed as limiting the scope of the invention set forth in the claims. The starting materials used in these examples are shown below in Table 1.

TABLE 1
Starting Materials

| | | Chemical Description, | |
|---|---|---|---|
| Ingredient Type | Product Name | Chemical formula, or Structure | Source |
| Pt catalyst | Karstedt's catalyst | platinum vinylmethylsiloxane | Dow |
| | | complex | |
| Catalyst | FC24; Triflic acid | Trifluoromethanesulfonic acid | Sigma |
| | | of formula (F₃C)S(═O)₂OH | Aldrich |
| Catalyst | potassium hydroxide | KOH | Fisher |
| | | | Scientific |
| Silane Reactant | methyltrimethoxysilane | MeSi(OMe)₃ | Acros |
| | | | Organics |
| Silane Reactant | vinyltrimethoxysilane | ViSi(OMe)₃ | TCI |
| Reactant | hexamethyldisiloxane | Me₃SiOSiMe₃ | Dow |
| Silane Reactant | octyltriethoxysilane | OctSi(OEt)₃ | Dow |
| Silane Reactant | dimethyldimethoxysilane | Me₂Si(OMe)₂ | Dow |
| Silane Reactant | 1,1,3,3-tetramethyldisiloxane | HMe₂SiOSiMe₂H | Alfa Aesar |
| Silane Reactant | octamethylcyclotetrasiloxane | D4 cyclics | Dow |
| Reactant | ETM converter | trimethoxysilylethyl-1,1,3,3- | Dow |
| | | tetramethyldisiloxane | |
| Silane Reactant | methyldimethoxysilane | MeHSi(OMe)₂ | Dow |
| Solvent | toluene | C₇H₈ | Fisher |
| | | | Scientific |
| Solvent | n-heptane | C₇H₁₆ | Fisher |
| | | | Scientific |
| Reactant | DI water | H₂O | Building |
| | | | Supply |
| Neutralizing | calcium carbonate | CaCO₃ | ? |
| agent | | | |
| Neutralizing | acetic acid | C₂H₄O₂ | Fisher |
| agent | | | Scientific |
| Moisture Cure | Bis(ethylacetoacetato-O1′,O3″) | TYZOR ™ PITA-SM | Dorf Ketal |
| Package | bis(propan-2-olato) titanium and | | |
| | methyltrimethoxysilane | | |
| Comparative | Solventless liquid methyl siloxane | DOWSIL ™ 2405 Resin | Dow |
| Resin | (no phenyl) resin, methoxy- | | |
| | functional, with 28 weight % | | |
| | methoxy content, 72 weight % | | |
| | silicone resin content | | |
| Comparative | Solventless liquid methyl siloxane | DOWSIL ™ US-CF-2403 Resin | Dow |
| Resin | (no phenyl) resin, methoxy- | | |
| | functional with molecular | | |
| | weight <1000 | | |

In this Reference Example 1, samples of vinyl-functional silsesquioxane resins were made as follows: A 1000 mL 3 neck flask was equipped with a magnetic stir bar, water-cooled condenser, thermocouple, and a nitrogen blanket. The following starting materials were loaded into the flask: 1) the methoxysilanes in amounts shown below in Table 2, and then triflic acid in the amount shown below in Table 2 was added. DI water in the amount shown below in Table 2 was added to the flask slowly, starting at RT. An exotherm was observed to 64° C. The flask contents were then heated at 65° C. for 2 h. A Dean Stark apparatus was used to distill off some methanol. The flask contents were cooled to 50° C., and CaCO₃ was added to neutralize the triflic acid. The flask contents were mixed overnight at RT. The resulting product was stripped on a rotary evaporator heated with an oil bath at a temperature of 80° C. under reduced pressure of 4 mmHg. The flask contents were then cooled to RT and pressure filtered through a 47 mm diameter Magna, Nylon, Supported, Plain 0.45 μm filter. A vinyl-functional silsesquioxane resin was produced.

In this Reference Example 2, samples of vinyl-functional MDT resins were prepared as described above in Reference Example 1, except octyltriethoxysilane and tetramethyldisiloxane were added. Samples CE2 and CE4 were prepared by this method. These samples are summarized below in Table 3.

In this Reference Example 3, samples of hydrido-functional silsesquioxane resins were made as follows: A 1 L 3 neck flask was equipped with a thermocouple, Teflon stir paddle attached to a glass stir rod, Dean Stark apparatus attached to a water-cooled condenser, and a nitrogen blanket. The following starting materials were loaded into the flask: the methoxysilane in the amount shown below in Table 2, and then triflic acid in the amount shown below in Table 2 was added. DI water in the amount shown below in Table 2 was added to the flask slowly, starting at RT. An exotherm was observed to 58° C. The flask contents were then heated at 65° C. for 30 min. The Dean Stark apparatus was used to distill off some methanol. Tetramethyldisiloxane was added to the flask, and then DI water was added to the flask, in the amounts shown below in Table 4. The flask contents were heated at 55° C. for 3 h. Methanol was then distilled out at a temperature in the flask of 70° C. The amount removed was 77 g. CaCO₃ was added to neutralize the triflic acid. The flask contents were mixed overnight at RT. The resulting product was stripped under reduced pressure of 3 mmHg using a rotary evaporator heated with an oil bath at a temperature of 80° C. The flask contents were then cooled to RT and pressure filtered through a 47 mm diameter Magna, Nylon, Supported, Plain 0.45 μm filter. A vinyl-functional silsesquioxane resin was produced. CE5 and CE6 were prepared using this process. CE6 used a different ratio of starting materials than CE5. These samples are summarized below in Table 4.

In this Reference Example 4, samples of octyl-functional DT resins were made as follows: The same apparatus was used as in Reference Example 1. Methyltrimethoxysilane (355 g), octyltriethoxysilane (41 g), and D4 cyclics (18 g) were added to the flask. Triflic acid (0.21 g) was then added, and DI water (71 g) was then added slowly starting at RT. An exotherm to 64° C. was observed, and the flask contents were then heated at 65° C. for 2 h. Some alcohol (methanol and ethanol) was distilled off using the Dean stark apparatus. The amount removed was 213 g. Next, n-heptane (144 g) was added, and then calcium carbonate (0.83 g) was added to neutralize the triflic acid. The flask contents were mixed for 1 h while cooling. Volatiles were distilled off up to a vapor temperature of 98° C. The amount removed was 91 g. the resulting product was filtered through a 47 mm diameter Magna, Nylon, Supported, Plain 0.45 μm filter. The resulting resin was stripped at 1-2 mmHg using a rotary evaporator heated with an oil bath at a temperature of 80° C. CE8 and CE9 were prepared using this process. These samples are summarized below in Table 4.

TABLE 2
Starting Materials Used in Comparative
Examples (amounts in grams)

| | Example | | |
|---|---|---|---|
| Starting Material | CE1 | CE3 | CE7 |
| MeSi(OMe)₃ | 355 | 354.9 | 354.9 |
| ViSi(OMe)₃ | 68 | 68.0 | 68.0 |
| Triflic acid | 0.21 | 0.21 | 0.21 |
| DI water | 68 | 71.8 | 71.8 |
| methanol removed | 190 | 204.0 | 207.1 |
| CaCO₃ | 0.84 | 0.84 | 0.84 |
| Heptane | 0 | 59.9 | 90.0 |
| Unit Formula of | T^{Me}_{0.843}T^{Vi}_{0.148} | T^{Me}_{0.856}T^{Vi}_{0.144} | T^{Me}_{0.853}T^{Vi}_{0.147} |
| Resin Produced | | | |
| Preparation Method | Reference | Reference | Reference |
| | Example 1 | Example 1 | Example 1 |

TABLE 3
Starting Materials Used in Comparative Examples (amounts in grams)

| | Example | |
|---|---|---|
| Starting Material | CE2 | CE4 |
| MeSi(OMe)₃ | 294.2 | 294.2 |
| ViSi(OMe)₃ | 66.7 | 66.7 |
| OctSi(OEt)₃ | 35.2 | 41.2 |
| D4 Cyclics | 17.8 | 17.8 |
| Triflic acid | 0.21 | 0.21 |
| DI water | 59.7 | 65.1 |
| Alcohol removed | 170.6 | 196.8 |
| CaCO₃ | 0.83 | 0.84 |
| Heptane | 0 | 156.0 |
| Unit Formula of | D^{Me2}_{0.088}T^{Me}_{0.728}T^{Octyl}_{0.040}T^{Vi}_{0.144} | D^{Me2}_{0.078}T^{Me}_{0.732}T^{Octyl}_{0.050}T^{Vi}_{0.140} |
| Resin Produced | | |
| Preparation Method | Reference Example 2 | Reference Example 2 |

TABLE 4
Starting Materials Used in Comparative Examples (amounts in grams)

| | Example | | | |
|---|---|---|---|---|
| Starting Material | CE5 | CE6 | CE8 | CE9 |
| MeSi(OMe)₃ | 355 | 354.9 | 356 | 356 |
| OctSi(OEt)₃ | 0 | 0 | 41 | 41 |
| D4 | 0 | 0 | 18 | 18 |
| Triflic acid | 0.18 | 0.18 | 0.21 | 0.21 |
| HMe₂SiOSiMe₂H | 31 | 43.7 | 0 | 0 |
| DI water | 55 + 4.1 | 55.2 + 4.1 | 71 | 71 |
| Alcohol removed | 118 + 77 | 115.1 + 82.9 | 213 | 213 |
| n-heptane | 0 | 0 | 144 | 144 |
| CaCO₃ | 0.71 | 0.71 | 0.83 | 0.83 |
| Unit Formula of | M^{H}_{0.102}T^{Me}_{0.892} | M^{H}_{0.137}T^{Me}_{0.855} | D^{Me2}_{0.08}T^{Me}_{0.87}T^{Oct}_{0.05} | D^{Me2}_{0.08}T^{Me}_{0.87}T^{Oct}_{0.05} |
| Resin Produced | | | | |
| Preparation | Reference | Reference | Reference | Reference |
| Method | Example 3 | Example 3 | Example 4 | Example 4 |

In this Reference Example 5, ETM-converted DT resins were prepared as follows: A 250 mL flask was equipped with a thermocouple, magnetic stir bar, and a water-cooled condenser. A vinyl functional resin with unit formula D^{Me2}_{0.009}T^{Me}_{0.843}T^{Vi}_{0.148} from Comparative Example 3 (50 g), ETM converter (26 g), and toluene (76 g) were loaded into the flask. A nitrogen blanket was applied. The flask contents were heated to 70° C., and Karstedt's catalyst (amount sufficient to provide 10 ppm Pt based on combined weights of the resin and ETM) was added. The flask contents were heated at 100° C. for 21 h. FTIR was used to monitor SiH content as indicator of reaction product. The resulting product was stripped to dryness at 0.5-1 mmHg using a rotary evaporator heated by an oil bath at a temperature of 80° C. Samples IE2, IE3, and IE5 were made by this procedure, by varying the amounts of starting materials. These samples are summarized below in Table 5. The amounts are in grams, unless otherwise indicated, in Table 5, below.

In this Reference Example 6, ETM-converted DT resins were prepared according to the method of Reference Example 5, except the resin of CE2 was used as the vinyl functional resin starting material for sample IE4, and the resin of CE4 was used as the vinyl functional resin starting material for sample IE6. These samples are summarized below in Table 6. The amounts are in grams, unless otherwise indicated, in Table 6, below.

In this Reference Example 7, samples IE7 and IE8 were prepared as follows: A 500 mL 3neck flask was equipped with a thermocouple, magnetic stir bar, and a water-cooled condenser. The flask was loaded with the resin of formula M^{H}_{0.102}T^{Me}_{0.892} Resin (sample CE5) or M^{H}_{0.102}T^{Me}_{0.892} Resin (sample CE6) and heptane. A nitrogen blanket was applied. The contents of the flask were heated to 80° C. Karstedt's Pt catalyst was added in an amount to equal 5 ppm Pt based on resin. Vinyltrimethoxysilane was added slowly with an addition funnel. Exotherm to 94° C. The contents of the flask were heated at ~100° C. for 3 h. FTIR was used to verify the reaction was complete. The product was stripped dryness at 1-2 mmHg using a rotary evaporator heated with an oil bath at a temperature of 80° C. These samples are summarized below in Table 7. The amounts are in grams, unless otherwise indicated, in Table 7, below.

In this Reference Example 8, sample 1E9 was prepared as follows: A 500 mL 3 neck flask was equipped with a thermocouple, magnetic stir bar, and a water-cooled condenser. Into the flask were loaded T^{Me}_{0.853}T^{Vi}_{0.147} Resin (150 g) prepared as described above, sample CE7, and heptane (81 g). A nitrogen blanket was applied. The flask contents were heated to 50° C., and then Karstedt's Pt catalyst was added in an amount to result in 5 ppm Pt based on resin+MeHSi(OMe)₂. MeHSi(OMe)₂ (30 g) was added to the flask slowly using an addition funnel.

The flask contents were heated at 60° C. for a total of 23 h. At the 5 h mark, additional Karstedt's Pt Catalyst was added sufficient to increase Pt concentration to 10 ppm, and then at the 22 h mark additional Karstedt's Pt catalyst was added sufficient to increase the Pt concentration to 15 ppm. The progress ofthe reaction was monitored reaction by FIR. The resulting product was stripped to dryness at 1-2 mmHg using a rotary evaporator heated with an oil bath at a temperature of 80 TC. This sample is summarized below in Table 8.

TABLE 5
Starting Materials for Working Examples (amounts in grams unless otherwise indicated)

| | Example | | |
|---|---|---|---|
| Starting Material | IE2 | IE3 | IE5 |
| D^{Me2}_{0.009}T^{Me}_{0.843}T^{Vi}_{0.148} | 50 | 50 | 0 |
| T^{Me}_{0.856}T^{Vi}_{0.144} | 0 | 0 | 110 |
| ETM converter | 26 | 26 | 56.5 |
| Toluene | 76 | 76 | 111.0 |
| Karstedt's catalyst | Amount sufficient to | Amount sufficient to | Amount sufficient to |
| | provide 10 ppm Pt | provide 10 ppm Pt | provide 15 ppm Pt |
| | based on weights of | based on weights of | based on weights of |
| | reactants | reactants | reactants |
| Unit Formula of | D^{Me2}_{0.009}T^{Me}_{0.843}T^{ETM}_{0.148} | D^{Me2}_{0.009}T^{Me}_{0.843}T^{ETM}_{0.148} | T^{Me}_{0.856}T^{ETM}_{0.144} |
| Resin Produced | | | |
| Preparation Method | Reference Example 5 | Reference Example 5 | Reference |
| | | | Example 5, |
| | | | except the resin |
| | | | of CE3 was used |
| | | | as the starting |
| | | | material instead |
| | | | of CE1 |

TABLE 6
Starting Materials for Working Examples IE4 and IE6

| | Example | |
|---|---|---|
| Starting Material | IE4 | IE6 |
| D^{Me2}_{0.088}T^{Me}_{0.728}T^{Oct}_{0.040}T^{Vi}_{0.144} | 50 | 50 |
| ETM converter | 26 | 26 |
| Toluene | 76 | 76 |
| Karstedt's catalyst | Amount sufficient to provide 10 | Amount sufficient to provide 10 |
| | ppm Pt based on weights of | ppm Pt based on weights of |
| | reactants | reactants |
| Unit Formula of Resin | D^{Me2}_{0.088}T^{Me}_{0.728}T^{Oct}_{0.040}T^{ETM}_{0.144} | D^{Me2}_{0.078}T^{Me}_{0.732}T^{Oct}_{0.050}T^{ETM}_{0.140} |
| Produced | | |
| Preparation Method | Reference Example 6 | Reference Example 6 |

TABLE 7
Starting Materials for Working Examples IE7 and IE8

| | Example | |
|---|---|---|
| Starting Material | IE7 | IE8 |
| Resin | 140 | 140 |
| Heptane | 114 | 114 |
| Vinyltrimethoxysilane | 30 | 30 |
| Toluene | 76 | 76 |
| Karstedt's catalyst | Amount sufficient to provide | Amount sufficient to provide |
| | 5 ppm Pt based on weight of | 5 ppm Pt based on weight of |
| | the resin | the resin |
| Unit Formula of Resin | M^{TM}_{0.102}T^{Me}_{0.892} | M^{TM}_{0.137}T^{Me}_{0.855} |
| Produced | | |
| Preparation Method | Reference Example 7 | Reference Example 7 |

Note: The resin of CE5 was used to prepare IE7, and the resin of CE6 was used to prepare 1E8.

TABLE 8
Starting Materials for Working Examples IE9

| | Example |
|---|---|
| Starting Material | IE9 |
| T^{Me}_{0.853}T^{Vi}_{0.147} Resin | 150 |
| Heptane | 81 |
| MeHSi(OMe)₂ | 30 |
| Karstedt's catalyst | 15 ppm based on weight of reactants |
| Unit Formula of Resin Produced | T^{Me}_{0.853}T^{DM}_{0.147} |
| Preparation Method | Reference Example 8 |

TABLE 9
Properties of Resins Prepared as Described Above

| Resin Synthesis | | FW | Physical State of |
|---|---|---|---|
| Examples | Composition (Si molar ratios) | (g/mol Si) | solventless resin |
| CE | D^{Me2}_{0.15}T^{Me}_{0.83}T^{Oct}_{0.02} | Not determined | Low viscosity liquid |
| CE1 | D^{Me2}_{0.009}T^{Me}_{0.843}T^{Vi}_{0.148} | 81.9 | low viscosity liquid |
| CE2 | D^{Me2}_{0.088}T^{Me}_{0.728}T^{Oct}_{0.040}T^{Vi}_{0.144} | 85.8 | low viscosity liquid |
| CE3 | T^{Me}_{0.856}T^{Vi}_{0.144} | 79.2 | viscous liquid |
| CE4 | D^{Me2}_{0.078}T^{Me}_{0.732}T^{Oct}_{0.050}T^{Vi}_{0.140} | 84.4 | viscous liquid |
| CE5 | M^{H}_{0.102}D^{Me2}_{0.006}T^{Me}_{0.892} | 76.4 | viscous liquid |
| CE6 | M^{H}_{0.137}D^{Me2}_{0.008}T^{Me}_{0.855} | 75.9 | viscous liquid |
| CE7 | T^{Me}_{0.853}T^{Vi}_{0.147} | 79.3 | viscous liquid |
| CE8 | D^{Me2}_{0.08}T^{Me}_{0.87}T^{Oct}_{0.05} | 79.5 | high viscosity liquid |
| CE9 | D^{Me2}_{0.08}T^{Me}_{0.87}T^{Oct}_{0.05} | 78.8 | very high viscosity |
| | | | liquid |

| | | | | | | grafted |
|---|---|---|---|---|---|---|
| Resin Synthesis | | | | OR (OMe + | OH | OMe |
| Examples | Mn | Mw | PD | OEt mol %) | (mol %) | (mol %) |
| CE | 2,638 | 10,854 | 4.11 | 49.3 | ~2.1 | 0 |
| CE1 | 1,486 | 3,206 | 2.16 | 55.7 | 1.2 | 0 |
| CE2 | 1,374 | 2,584 | 1.88 | Not determined | 1.0 | 0 |
| CE3 | 1,824 | 5,108 | 2.80 | 43.55 | 3.51 | 0 |
| CE4 | 1,697 | 4,111 | 2.42 | ~40.4 | ~3.1 | 0 |
| CE5 | 2,250 | 4,785 | 2.13 | 39.65 | 0.76 | 0 |
| CE6 | 1,820 | 3,396 | 1.87 | 37.37 | 1.64 | 0 |
| CE7 | 1,715 | 4,415 | 2.58 | 43.35 | 4.94 | 0 |
| CE8 | 3,017 | 26,152 | 8.67 | 25.3 | 8.2 | 0 |
| CE9 | 3,624 | 47,861 | 13.21 | 22.1 | 6.1 | 0 |

| Resin Synthesis | | FW | Physical State of |
|---|---|---|---|
| Examples | Composition (Si molar ratios) | (g/mol Si) | solventless resin |
| IE1 | M_{0.24}D^{Me2}_{0.01}T^{Me}_{0.69}T^{ETM}_{0.06} | | viscous liquid |
| IE2 | D^{Me2}_{0.009}T^{Me}_{0.843}T^{ETM}_{0.148} | | low viscosity liquid |
| IE3 | D^{Me2}_{0.009}T^{Me}_{0.843}T^{ETM}_{0.148} | | low viscosity liquid |
| IE4 | D^{Me2}_{0.088}T^{Me}_{0.728}T^{Oct}_{0.040}T^{ETM}_{0.144} | | low viscosity liquid |
| IE5 | T^{Me}_{0.856}T^{ETM}_{0.144} | | viscous liquid |
| IE6 | D^{Me2}_{0.078}T^{Me}_{0.732}T^{Oct}_{0.050}T^{ETM}_{0.140} | | viscous liquid |
| IE7 | M^{TM}_{0.102}D^{Me2}_{0.006}T^{Me}_{0.892} | | viscous liquid |
| IE8 | M^{TM}_{0.137}D^{Me2}_{0.008}T^{Me}_{0.855} | | liquid |
| IE9 | T^{Me}_{0.853}T^{DM}_{0.147} | | viscous liquid |

| | | | | | | grafted |
|---|---|---|---|---|---|---|
| Resin Synthesis | | | | OR (OMe + | OH | OMe |
| Examples | Mn | Mw | PD | OEt mol %) | (mol %) | (mol %) |
| IE1 | n/a | n/a | n/a | 1.60 | 0.64 | 18.9 |
| IE2 | n/a | n/a | n/a | 55.7 | 1.2 | 44.4 |
| IE3 | n/a | n/a | n/a | 55.7 | 1.2 | 44.4 |
| IE4 | n/a | n/a | n/a | 51.3 | 1.0 | 43.2 |
| IE5 | n/a | n/a | n/a | 43.6 | 3.5 | 43.2 |
| IE6 | n/a | n/a | n/a | ~40.4 | ~3.1 | 42.0 |
| IE7 | 2,099 | 4,831 | 2.30 | 39.7 | 0.8 | 30.6 |
| IE8 | n/a | n/a | n/a | 37.4 | 1.6 | 41.1 |
| IE9 | 2,354 | 9,014 | 3.83 | 43.4 | 4.9 | 29.4 |

In this Reference Example 9, curability of some of the resins prepared as described above was tested by combining 99 weight parts of resin and 1 weight part of a Moisture Cure Package (TYZOR™ PITA-SM) were mixed using a dental mixer at 2000 rpm for 30 sec. The resulting coating compositions were homogeneous clear liquids. The compositions were stabilized for 24 h and then applied to substrates.

Each composition was coated onto A-36 aluminum Q-panels with a 10 mil draw down square (5 cm wide) at 25 mm/sec using a Zehntner auto coater (ZAA2300) with vacuum board. After applying each composition, the surface of each resulting coating was tested for tack every 60 seconds until tack free time was achieved. The tack-free time was recorded where the finger was released with no wet coating adhered onto the nitrile glove after being gently pressed against the coating surface and released immediately.

Tables 10 and 11, below, show that tack-free times of less than 30 min could be achieved only for resins that contained alkoxy functionality post-grafted to the resin through the vinyl or SiH moieties present on the resin. This provides for the first time an avenue towards fast cure alkoxy functional siloxane resins where the alkoxy groups on the resin are not just those left over from the synthesis but deliberately introduced at a desired concentration and away from the resin core.

TABLE 10
Comparative Examples tested for Tack Free Time

| Tested Properties | Criteria | CE | CE1 | CE2 | CE4 | CE6 |
|---|---|---|---|---|---|---|
| Tack-free time (min) | <30 min | 30.5 | >60 | 240 | >30 | >60 |

Note: In Table 10, the sample labeled CE was DOWSIL™ 2405 Resin, which is commercially available from Dow.

TABLE 11
Working Examples tested for Tack Free Time

| Tested Properties | Criteria | IE1 | IE3 | IE4 | IE6 | IE8 |
|---|---|---|---|---|---|---|
| Tack-free time (min) | <30 min | 25 | 19 | 13 | 8 | 19 |

### Definitions and Usage of Terms

All amounts, ratios, and percentages herein are by weight, unless otherwise indicated by the context of specification. The articles ‘a’, ‘an’, and ‘the’ each refer to one or more, unless otherwise indicated by the context of specification. The singular includes the plural unless otherwise indicated by the context of specification. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. Any feature or aspect of the invention may be used in combination with any other feature or aspect recited herein. The abbreviations used herein have the definitions in Table 12.

TABLE 12
Abbreviations

| Abbreviation | Description |
|---|---|
| ° C. | Degrees Celsius |
| CE | Comparative Example |
| D^{Me2} | A difunctional siloxane unit of formula (Me₂SiO_{2/2}) |
| DI | deionized |
| Dow | The Dow Chemical Company of Midland, Michigan, USA |
| Et | ethyl |
| FTIR | Fourier Transfer Infra Red |
| g | gram |
| GPC | gel permeation chromatography |
| h | hour |
| IE | Working Example |
| kPa | kilopascal |
| Me | methyl |
| M^{H} | A monofunctional siloxane unit of formula (HMe₂SiO_{1/2}) |
| M^{TM} | An alkoxy grafted monofunctional siloxane unit of formula (R^{TM}Me₂SiO_{1/2}), |
| | where R^{TM} is |
| | —C₂H₄Si(OMe)₃ |
| min | minute |
| mL | milliliter |
| mm | millimeter |
| mmHg | millimeters of mercury |
| Mn | Number average molecular weight measured by GPC |
| mol | mole |
| Mw | Weight average molecular weight measured by GPC |
| NVC | Non-volatile content |
| Oct | octyl |
| PDI | Polydispersity index |
| rpm | Revolutions per minute |
| RT | Room temperature of 23 ± 3° C. |
| sec | second |
| T^{DM} | An alkoxy grafted trifunctional siloxane unit of formula (R^{DM}SiO_{3/2}), where |
| | R^{DM} is —C₂H₄SiMe(OMe)₂ |
| T^{ETM} | An alkoxy grafted trifunctional siloxane unit of formula (R^{ETM}SiO_{3/2}), where |
| | R^{ETM} is a trimethoxysilylethyl-1,1,3,3-tetramethyldisiloxy group |
| T^{Me} | A trifunctional siloxane unit of formula (MeSiO_{3/2}) |
| T^{Oct} | A trifunctional siloxane unit of formula (OctSiO_{3/2}) |
| T^{Vi} | A trifunctional siloxane unit of formula (ViSiO_{3/2}) |
| THF | tetrahydrofuran |
| μm | micrometer |
| Vi | vinyl |

### Test Methods

An example of a test method for determining hydrolyzable group content of a silsesquioxane resin is as follows. Hydrolyzable group content is analyzed by ²⁹Si and ¹³C NMR in deuterated benzene. Total hydrolyzable content is determined from ²⁹Si NMR analysis and is reported as a molar fraction based on Si units. The amount of this hydrolyzable group content that was methoxy is determined from ¹³C NMR analysis (1,4-dioxane is used as an internal standard). The difference between the total hydrolyzable group content and the amount of methoxy was the amount of OH groups present.

GPC Samples were prepared in certified THE at 1% w/w concentration, filtered with a 0.45 m PTFE syringe filter, and analyzed against polystyrene standards. The relative calibration (3rd order fit) used for molecular weight determination was based on 12 polystyrene standards ranging in molecular weights from 580 to 1,735,000 Daltons. The chromatographic equipment consisted of a Viscotek GPCmax VE2001 Solvent/Sample Module equipped with a vacuum degasser, a Viscotek VE3580 RI detector, and two (300 mm×7.5 mm) Polymer Laboratories Mixed C columns (molecular weights separation range of 200 to 3,000,000) preceded by a guard column. The separation was performed using certified grade THE programmed to flow at 1.0 mL/min, injection volume was set at 100 μL and columns and detector were heated to 35° C. Data collection was 30 minutes and processing was performed using OmniSEC software.

1. An alkoxy-functional silsesquioxane resin comprising unit formula:
(R²₃SiO_{1/2})_{c}(R²₂SiO_{2/2})_{d}(R²SiO_{3/2})ₑ(ZO_{1/2})_{f}(HO_{1/2})_{g}; where
each R² is independently selected from the group consisting of an alkyl group and a group of formula (I) 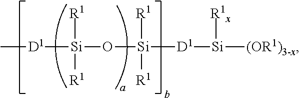
where in formula (I),
each R¹ is an independently selected alkyl group,
each D¹ is an independently selected alkylene group,
subscripts a, b, and x are integers with values such that
subscript a is 1 or 2,
subscript b is 1, and
subscript x is 0 or 1;
with the proviso that an average of 5 mol % to 25 mol % of R², per molecule, have formula (I);
subscripts c, d, and e represent mole fractions of each unit in the alkoxy-functional silsesquioxane resin and subscripts c, d, and e have values such that
$$0 \leq c \leq 0.25 ,$$
$$0 \leq d \leq 0.20 ,$$
$$0.55 < e \leq 1 , and$$
$$a quantity ( c + d + e ) = 1 ;$$
each Z is an independently selected alkyl group; and
subscript f represents a molar amount of alkoxy groups in the resin, and subscript g represents a molar amount of hydroxyl groups in the resin, and subscripts f and g have values such that
$$0.01 \leq f \leq 0.7 ;$$
$$0 \leq g \leq 0.05 ; and$$
$$0.02 \leq ( f + g ) \leq 0.75 ;$$
where the alkoxy-functional silsesquioxane resin is in a liquid state at 23° C.±3° C. and 101.325 kPa.

2. The silsesquioxane resin of claim 1, where
subscript a=1,
each D¹ has empirical formula —C₂H₄—,
each R¹ is methyl,
each R² that is not a group of formula (I) is methyl, and
each Z is independently selected from the group consisting of methyl and ethyl.

3. (canceled)

4. The alkoxy-functional silsesquioxane resin of claim 1, where R² has formula (I) in at least one instance of the unit (R²SiO_{3/2}), per molecule.

5. The alkoxy-functional silsesquioxane resin of claim 1, where the alkoxy-functional silsesquioxane resin has a weight average molecular weight of 1,000 g/mol to 15,000 g/mol measured by gel permeation chromatography.

6. A method for preparing the alkoxy-functional silsesquioxane resin of claim 1, where the method comprises:
1) combining, under conditions to effect hydrosilylation reaction, starting materials comprising
A) an alkoxy-functional organosilicon compound, and
B) a silsesquioxane resin,
with the proviso that one of A) the alkoxy-functional organosilicon compound and B) the silsesquioxane resin has a silicon bonded hydrogen atom and the other of A) the alkoxy-functional organosilicon compound and B) the silsesquioxane resin has an aliphatically unsaturated group capable of undergoing hydrosilylation reaction,
in the presence of C) a hydrosilylation reaction catalyst, and
optionally D) a solvent,
thereby forming a hydrosilylation reaction product comprising the alkoxy-functional silsesquioxane resin, and
optionally 2) purifying the hydrosilylation reaction product.

7. (canceled)

8. A method for preparing the alkoxy-functional silsesquioxane resin of claim 1, the method comprising:
1) combining, under conditions to effect hydrosilylation reaction, starting materials comprising
A) an alkoxy-functional organohydrogensiloxane oligomer of formula: 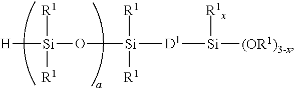
where R¹, D¹, a, and x are as described above; and
B) an alkenyl-functional silsesquioxane resin of unit formula.
(R³₃SiO_{1/2})_{c}(R³₂SiO_{2/2})_{d}(R³SiO_{3/2})ₑ(ZO_{1/2})(HO_{1/2})_{g}, where Z, c, d, e, f, and
g are as described above, and
each R³ is independently selected from the group consisting of an alkyl group and an alkenyl group,
with the proviso that at least one R³, per molecule, is an alkenyl group;
in the presence of C) a hydrosilylation reaction catalyst; and
optionally D) a solvent.

9. (canceled)

10. A moisture curable composition comprising:
I) the alkoxy-functional silsesquioxane resin of claim 1, and
II) a condensation reaction catalyst.

11. The composition of claim 10, further comprising an additional starting material selected from the group consisting of: III) a solvent, IV) an alkoxysilane, V) a fluorescent whitening agent, a UV indicator, or both, VI) a corrosion inhibitor, VII) a chelating agent, VIII) an adhesion promoter, and IX) a combination of two or more thereof.

12. The composition of claim 10, where the composition contains up to 100 ppm by weight of organic solvent, which is residual in the starting materials used to prepare the moisture curable composition.

13. A method of preparing a film, where the method comprises:
1) applying the moisture curable composition of claim 10 on a substrate, and
2) forming the film on the substrate from the moisture curable composition.

14. The method of claim 13, where forming the film on the substrate comprises
forming a wet film on the substrate and
drying the wet film on the substrate to form the film, wherein drying the wet film comprises
optionally (i) evaporating solvent from the wet film, when solvent is present,
optionally (ii) exposing the wet film to an elevated temperature to drive solvent therefrom, when solvent is present,
(iii) curing the wet film, or
(iv) any combination of (i) to (iii).

15. A film prepared by the method of claim 13.

16. The composition of claim 11, where the composition contains up to 100 ppm by weight of organic solvent, which is residual in the starting materials used to prepare the moisture curable composition.

17. A method of preparing a film, where the method comprises:
1) applying the moisture curable composition of claim 11 on a substrate,
2) forming the film on the substrate from the moisture curable composition.

18. A method of preparing a film, where the method comprises:
1) applying the moisture curable composition of claim 2 on a substrate,
2) forming the film on the substrate from the moisture curable composition.

19. The composition of claim 11, where IV) the alkoxysilane is present and has general formula R⁶ᵢ Si(OR⁷)₍₄₋ᵢ₎, where R⁶ is a monovalent hydrocarbon group, R⁷ is an alkyl group, and subscript i is an integer with a value of 0 to 2.

20. The composition of claim 19, where IV) the alkoxysilane comprises methyltrimethoxysilane.

21. The composition of claim 10, where II) the condensation reaction catalyst is selected from the group consisting of tin compounds, titanium compounds, and zirconates.

22. The composition of claim 21, where II) the condensation reaction catalyst comprises Bis(ethylacetoacetato-O1′, O3″) bis(propan-2-olato) titanium.
